(19) United States
(12) Patent Application Publication
(10) Pub. No.: US 2026/0243704 A1
(43) Pub. Date: Aug. 20, 2026

(54) ULTRA-FAST SCANNING X-RAY IMAGING DEVICE WITH LIVE DYNAMIC OFFSET CALIBRATION

(71) Applicant: ATHLOS OY, Espoo (FI)

(72) Inventors: Konstantinos SPARTIOTIS, Espoo (FI); Dimitrios CHATZISTRATIS, Nea Artaki (GR); Kimmo Olavi KARHUNEN, Espoo (FI); Matthew POWELL, Espoo (FI); Tom Gunnar SCHULMAN, Porvoo (FI)

(21) Appl. No.: 19/057,680

(22) Filed: Feb. 19, 2025

(51) Int. Cl. G01N 23/04

(52) U.S. Cl. CPC G01N 23/04; G01N 2223/1016; G01N 2223/303; G01N 2223/316; G01N 2223/5015

(57) ABSTRACT

A linear array ultra-fast scanning (“UFS”) x-ray imaging device is single photon sensitive, operating in frame output mode and including a pixel array Application Specific Integrated Circuit including the readout pixel array. The device includes a collimator overlaying and aligned on top of the direct conversion detector allowing partial illumination of the detector active area. The non-illuminated area data is collected simultaneously with image data and is used live and in real time to correct the offset of each imaging pixel. In this way a stable, uniform and reliable UFS is achievable without the limitations, instability and artifacts of expensive photon counting direct conversion sensors.

### CROSS REFERENCE TO RELATED APPLICATIONS

None. This is a new utility application.

### FIELD OF THE INVENTION

The present invention relates to x-ray imaging devices and more specifically to x-ray imaging devices suitable for ultra-fast scan imaging for a variety of applications, including inline x-ray imaging inspection in the food processing and packing industry, inline PCB and electronics inspection, tire inspection, pipe weld inspection, inline inspection in the pharmaceutical industry etc.

### BACKGROUND OF THE INVENTION

This section illustrates useful background information without admission of any technique described herein representative of the state of the art.

A variety of digital, real time x-ray imaging devices have been developed and have become available for x-ray imaging over the past twenty years. Such x-ray imaging devices utilize scintillator convertor such as CsI coupled to a Complementary Metal Oxide Semiconductor (“CMOS”) readout application specific integrated circuit (“ASIC”). In this case the x-rays convert to visible or near visible light in the scintillator and thereafter produce an electronic signal on the photodiodes that exist on each pixel on the CMOS. Alternatively x-ray scanning imaging devices are of the direct conversion type where the x-rays convert directly to an electronic pulse inside the bulk of a semiconductor substrate. Such examples include detectors such as CdTe, CdZnTe, HgI₂, GaAs, Ge, Se, Si etc. The electric pulse is drifting under the influence of an electric field applied with a high voltage across the bulk. Typical high voltage values applied to create the electric field are from few tens of volts and up to 1,000 Volts or even higher. The high voltage polarity can be positive or negative depending on if one wants to collect electrons or holes.

The x-ray scanning imaging devices or otherwise known as linear arrays operate in the so-called Time Delay Integration mode (“TDI”) for outputting the image line by line or in the so called frame output mode for outputting frames instead of lines, much like a video streaming device. Direct conversion TDI linear arrays can achieve impressive high speeds for inline inspection. The assignee of the current invention has made several inventions comprising substantial advancements to resolve the drawbacks of the prior art. These inventions are described in U.S. Pat. Nos. 11,653,886B2, 11,647,972B2 and 11,559,267B2 all of which are incorporated herein as background art by reference. The inventions described therein can achieve speeds of 5,000 fps, 10,000 fps, 20,000 fps or more.

A problem in direct conversion linear arrays is the polarization and temporal behavior of CdTe detectors and CdZnTe detectors that are becoming popular due to their high sensitivity. However, polarization introduces a time dependent calibration which makes these sensors difficult to operate. Even more severe is the issue when the CdTe-CMOS scanner operates at very high speeds and continuously. Prior art describes depolarizing switching high voltage circuitries. However, the approach does not work when the imaging device is active continuously because the circuitry and solution suggested are too slow and hundreds of milliseconds are lost as dead time. Therefore, in an inline inspection system the approach of switching on/off an HV for example every 10 seconds, 30 seconds or 1 minute would not work. Additionally, when the HV on/off operation happens in such long time intervals, it means that the frames produced in between will have a temporal response. Almost each frame needs to be calibrated with a time dependent function. In other words the calibration needs to take into account that the frames have different gain characteristics from one another. This has been a big problem in the industry.

The assignee of the current invention has made several inventions comprising substantial advancements to resolve the aforementioned drawbacks of the prior art, by introducing ultra-fast HV switching applied to the CdTe-CMOS linear array. These inventions are described in U.S. Pat. Nos. 11,653,886B2, 11,647,972B2 and 11,559,267B2 all of which are incorporated herein as background art by reference.

However there remains the key issue of achieving a stable performance over time of a CdTe or CdZnTe ultra-fast scanner or any other direct conversion type of x-ray imaging scanner. Stability becomes a critical issue in inline inspection used for example in the food packing industry where the x-ray imaging scanner operates 24 hours per day, 7 days per week, typically referred to as 24/7 mode of operation.

To exemplify this technical problem the most expensive direct conversion linear arrays used for inline inspection for dual and single energy imaging (eg in food inspection) as of today are based on the photon counting principle, which were invented by Spartiotis et al in 1996 and two US patents were issued: U.S. Pat. Nos. 6,248,990 (B1) & 6,355,923 (B2). Unfortunately these photon-counting direct conversion linear arrays suffer from instability, require frequent recalibration as a function of materials to be inspected, contain artifacts in the live video stream and temporal behavior. All of these limitations reduce substantially the efficacy of the system and create false positives, i.e. false rejections of food items. This is a serious limitation for inline applications that require the utmost stability and very few or no artifacts. Next, we explain in this background section what the authors have discovered as of the date of filing this application to be the root physics-cause for these issues in these very expensive direct conversion photon-counting linear arrays:

The X-ray signal response of semiconductor-CMOS sensors depends on factors such as temperature and humidity which influence the characteristics of both the CMOS signal readout circuitry and the semiconductor detector crystal. These characteristics include, e.g., signal leakage paths of the CMOS amplifiers, semiconductor detector dark current and charge trapping, polarization etc. Common to the effects on the sensor characteristics is that they cause a continuously changing offset level that must be accurately corrected by calibration for the sensor to produce X-ray images free of artifacts, fixed pattern noise etc. A conventional method of offset correction in X-ray scans of short duration (typically 10-30 s) is to acquire a dark (X-rays off) image immediately before and/or after the scan and use these dark images to subtract the offset from the acquired X-ray image data. This method relies on the fact that in short scans the offset change between the time of X-ray and dark data acquisition is minimal and linear with time.

However, during long continuous X-ray scans (several minutes, hours or even days) the offset may drift significantly and because the X-ray irradiation is constantly on it is not possible to acquire updated dark images for accurate offset correction. One method of offset calibration in long continuous X-ray scans is to prerecord dark data as a function of temperature and to use this data for offset correction during the actual X-ray scan. The prerecorded data can be used as look up tables or to calculate correction functions of temperature by fitting, e.g., polynomials to the data and then use these polynomials to subtract the offset level from the X-ray data. This approach naturally requires one or more temperature sensors located as close as possible to the semiconductor-CMOS sensor hybrids or preferably on the CMOS. However, the temperature of the semiconductor detector material may not necessarily follow accurately the CMOS temperature. In simple words the temperature sensors can never really be close enough to the CdTe or CdZnTe to read accurate enough their temperature. Furthermore, the signal response of the semiconductor detector crystal depends on other factors as well and not on the temperature alone. Therefore, the method of using prerecorded data to calibrate the sensor vs. temperature may not be accurate enough to remove offset variation between sensor pixels.

### SUMMARY

It has been observed that it would be extremely desirable and a major advancement in the field of x-ray imaging scanning devices to have an ultra-fast scanning CMOS imager without the bottlenecks of the photon-counting prior art and to do so in a cost-efficient manner. Embodiments of the current invention provide for an ultra-fast scanning imaging device with the following features and advantages:
Scanning speeds of up to 64 meters/sec (228 km/hour) with 400 micrometer resolution or 1 meter/sec (60 meters/minute) with 100 micro meter resolution and other speeds and resolutions in between.
Frame rates of up to 10,000 frames per second (fps) with 100 micrometer resolution. Respectively this corresponds to frame periods of 100 microseconds. Or with binning 2×2 and 4×4 achieve four and sixteen times the above frame rate with 200 micro meter and 400 micrometer resolution, respectively.
Direct conversion x-ray imaging ultra-fast scanners, suitable for continuous operation without temporal behavior of the individual frames used in the image reconstruction. This is achieved with dynamic offset calibration device “DOC”. A DOC device is a direct conversion ultra-fast scanner that self compensates, live, in real time and at ultra-high speeds to mitigate drifting and temporal behavior caused by the CdTe or CdZnTe dark current, temperature dependent drifting of the CMOS and other temporal behavior of the parts and component of the direct conversion scanner. The result is stable 24/7 operation using a DOC device, such operation providing uniform and stable performance.

A DOC device comprises in accordance with the current invention a semiconductor crystal and a part of said semiconductor detector crystal is covered by a collimator which completely absorbs the impinging X-rays. Likewise, the CMOS readout circuit is divided into two sections one of which collects the X-ray signal data from the non-covered part of the detector crystal and the other section the dark signal data from the shielded part of the detector.

To create calibration functions for continuous real time offset correction a set of calibration dark data is acquired. During the factory calibration data acquisition, the temperature of the sensor is ramped from a low temperature to a higher temperature or vice versa. The changing temperature affects the signal (data) response of the detector crystal and the CMOS readout circuit. A similar change in the detector can be induced by other means as well than by changing the temperature, e.g., by altering the ambient humidity. Data is recorded from both sections of the CMOS circuit. Thus, two sets of signals (data) are obtained: 1) Image signal data from the non-shielded sensor (i.e. detector for example CdTe or CdZnTe) part and 2) reference signal data from the shielded sensor (i.e. detector for example CdTe or CdZnTe) part. Both sets contain the sensor dark response of the region from where it is acquired. The response depends on the state of the detector crystal and the CMOS which again are altered by changing, e.g., the temperature. The offset calibration of the image data relies on the assumption that the drifting offset of the image data correlates with the reference data in real time.

Offset calibration functions are calculated by plotting the dark image data offset against the reference data for each sensor pixel and by fitting a function to the data for each pixel. The offset calibration functions can be linear functions or polynomials of a desired order or any other functions of a shape that fits the data with low fit residuals. Once the calibration functions have been calculated they can be used to correct the offsets of acquired X-ray image pixel values by feeding the reference data values as variables to the offset calibration functions. Since the reference data is collected simultaneously with the X-ray image data and since its pixel values originate from the same semiconductor-CMOS hybrid from a location very close to the image pixels it accurately correlates in real time to the image data and produces a dynamic offset calibration with very high accuracy.

Embodiments of the invention finds particular application in industrial inline inspection, automatic x-ray inspection and industrial CT. Specific preferred embodiments include x-ray imaging inspection in the food processing and packing industry, inspection of welds and pipes in the oil and gas industry, electronic and assembled PCB and other inline inspection applications.

In accordance with a first aspect of the invention we provide an x-ray imaging device, comprising:
a. a direct conversion detector for detecting impinging x-rays and generating output electronic signals in response to impinging x-rays;
b. an application specific integrated circuit bump-bonded to said direct conversion detector for receiving said detector output electronic signals and comprising a readout pixel array and electronics for producing output pixel values;
c. A collimator overlaying and aligned with said direct conversion detector
characterized in that
said collimator aligned on top of the direct conversion detector is narrower than the active width of said direct conversion detector to allow X-rays (6) to partially illuminate the active width of said direct conversion detector.
In accordance with a second aspect of the invention we provide an x-ray imaging device characterized in that said application specific integrated circuit is divided into 2 regions:
d. a first region (11) configured to collect the output electronic signals (data) in response to impinging X-rays from the part of the direct conversion detector that is not shielded by the collimator and
e. a second region configured to collect the output electronic signals (data) from the part of the direct conversion detector that is shielded.
In accordance with a third aspect of the invention we provide an x-ray imaging device characterized in said second region collected signal data is used as reference data to perform real time offset correction to said signal data from first region.
In accordance with a fourth aspect of the invention we provide an x-ray imaging device characterized in that said signal data collected from the first region is offset corrected for every pixel by the offset calibration functions as

$$OffsetCorrectedImage = \vert RawImage - OffsetCorrectionFunction ( Ref ) \vert$$

where the function argument Ref is the set of values of the reference data acquired from said second (reference) region of the application specific integrated circuit simultaneously with the data collected from said first region of the application specific integrated circuit simultaneously.

In certain embodiments, the said detector is a direct conversion detector from the group of CdTe, CdZnTe, GaAs, Ge, HgI2, Si and Se.

In certain embodiments, the said CdTe is of the type with Al Schottky contacts on the pixel side.

Different non-binding example aspects and embodiments have been presented in the foregoing. The above embodiments and embodiments described later in this description are used to explain selected aspects or steps that may be utilized in implementations of the present invention. It should be appreciated that corresponding embodiments apply to other example aspects as well. Any appropriate combinations of the embodiments can be formed.

### BRIEF DESCRIPTION OF THE DRAWINGS

FIG. 1. A schematic 3D view of the X-ray sensor and its collimator.
(1) Sensor PCB
(2) Semiconductor-CMOS ASIC hybrid
(3) CMOS ASIC
(4) Collimator
(5) Physical gap between sensor hybrids
(6) X-ray
(10) Semiconductor crystal.

FIG. 2. A schematic top view of the sensor and its collimator.
(4) Collimator
(7) Collimator opening
(8) Reference region of the sensor (=detector)
(9) Image region of the sensor (=detector).

FIG. 3. A 3D schematic view of the semiconductor-CMOS ASIC hybrid.
(8) Reference region of the semiconductor crystal
(9) Image region of the semiconductor crystal
(11) Image region of the CMOS ASIC
(12) Reference region of the CMOS ASIC.

FIG. 4. A data plot of the image region offset vs. the reference region offset values of one pixel together with a linear best fit offset correction function.

### DETAILED DESCRIPTION

With reference now to the accompanying figures we describe in detail the invention and the preferred embodiments.

The description below is an exemplary embodiment of the invention to provide an X-ray scanning sensor operated in the time delayed integration (TDI) line output mode. Equally the invention applies also to sensors operated in the frame output mode.

FIG. 1 shows, as an example, a scanning X-ray sensor with an active area of 44×1541 pixels (or 4.4×15.41 mm² with 100 μm pixel pitch). The sensor in FIG. 1 consists of 6 separate CdTe-CMOS hybrids (2). The number of hybrids or the sensor length and width are, however, not limited to any specific values. The hybrids are mounted and wire bonded to a printed circuit board (1). Each hybrid comprises (in this example) 44×256 pixels. A physical gap (5) of a width of one pixel is left between the hybrids. A collimator (4) is aligned on top of the detector, for example CdTe or CdZnTe, to allow X-rays (6) to illuminate only one part of the active detector width, for example CdTe or CdZnTe, hybrids as shown in FIG. 2 which is a top view of the scanning X-ray sensor. The enlarged detail in FIG. 2 illustrates the position of the collimator opening (7). The collimator blocks the reference region (8) of the CdTe detector crystal from X-rays but not the image region (9). FIG. 3 shows one CdTe-CMOS hybrid with the CdTe detector crystal (10) bump bonded to the CMOS circuit (3). The CMOS of each hybrid is divided into 2 regions. The first region (11) comprises 32 rows and 256 columns of pixels and the second region (12) 12 rows and 256 columns. The first region collects the X-ray signal response of the part of the CdTe semiconductor active detector width that is not shielded by the collimator while the second region of the CMOS records the shielded part of the CdTe active detector width (dark signal response). In this embodiment the data is output from the CMOS as frames to an FPGA circuit which performs the TDI summation of the pixel rows and outputs the line data separately for the two CMOS regions. The TDI summation could, however, alternatively be done by the CMOS.

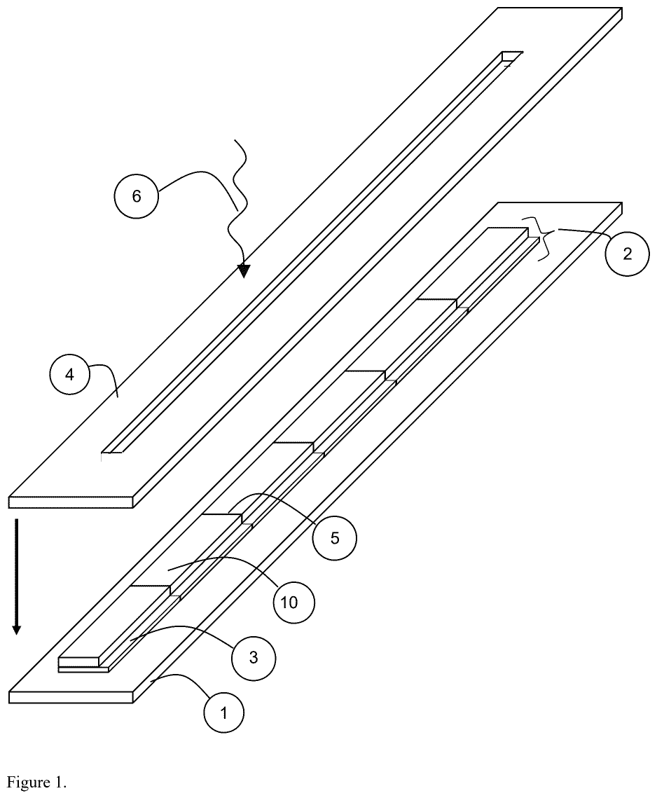

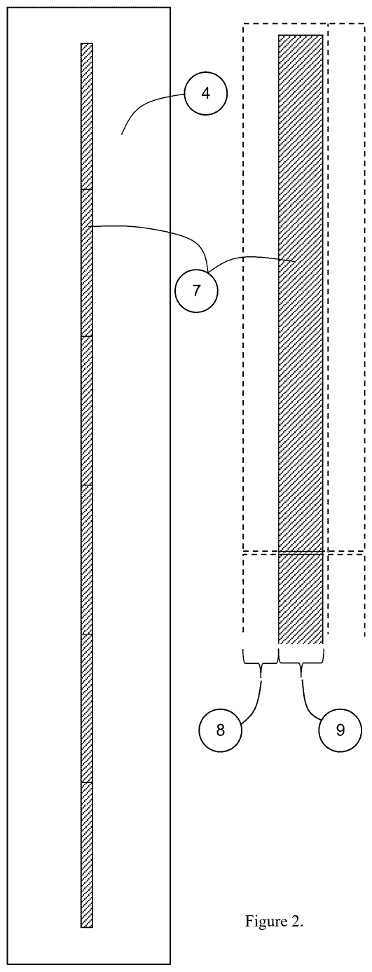

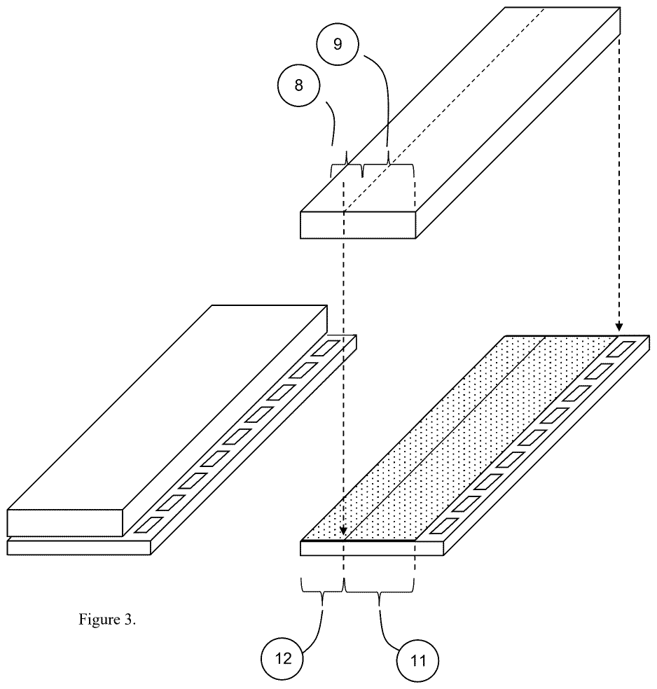

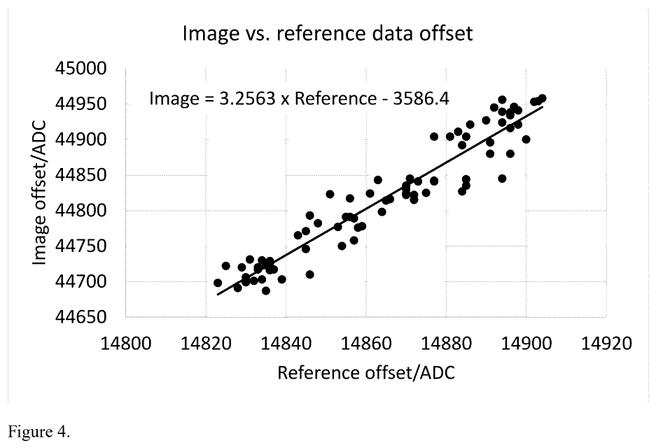

To calculate the offset calibration functions a set of dark data is first collected from the X-ray sensor while simultaneously changing the temperature of the sensor. Both the reference region and the image region data are recorded. The varying temperature causes both the image data and the reference data to change during the acquisition. The data of each image region pixel in the TDI line output is then plotted against the corresponding reference data pixel. Finally a linear function (or e.g., a polynomial) is fitted to the data for each pixel and the function coefficients are saved in an offset calibration file. An example of a data plot and a calibration function fit for one pixel is shown in FIG. 4.

During X-ray image acquisition of an object the image data collected from the image region is offset corrected for every pixel by the offset calibration functions as

$$OffsetCorrectedImage = \vert RawImage - OffsetCorrectionFunction ( Ref ) \vert$$

where the function argument Ref is the set of values of the reference data acquired from the reference region of the sensor simultaneously with the image data.

The foregoing description has provided by way of non-limiting examples of particular implementations and embodiments of the invention a full and informative description of the best mode presently contemplated by the inventors for carrying out the invention. It is however clear to a person skilled in the art that the invention is not restricted to details of the embodiments presented above, but that it can be implemented in other embodiments using equivalent means without deviating from the characteristics of the invention.

Furthermore, some of the features of the above-disclosed embodiments of this invention may be used to advantage without the corresponding use of other features. As such, the foregoing description should be considered as merely illustrative of the principles of the present invention, and not in limitation thereof. Hence, the scope of the invention is only restricted by the appended patent claims.

1. A real time x-ray imaging device, comprising:
a direct conversion detector configured to detect impinging x-rays and generating output electronic signals in response to impinging x-rays;
an application-specific integrated circuit bump-bonded to said direct conversion detector configured to receive said detector output electronic signals, the application-specific integrated circuit comprising a readout pixel array and electronics configured to produce output pixel values; and
a collimator overlaying and aligned with said direct conversion detector, said collimator being aligned on top of the direct conversion detector and being narrower than an active width of said direct conversion detector to allow X-rays to partially illuminate the active width of said direct conversion detector.

2. The x-ray imaging device according to claim 1, wherein said application-specific integrated circuit is divided into two regions including:
a first region configured to collect the output electronic signals in response to impinging X-rays from a part of the direct conversion detector that is not shielded by the collimator as first region signal data, and
a second region configured to collect the output electronic signals from another part of the direct conversion detector that is shielded as second region collected signal data.

3. The x-ray imaging device according to claim 2, wherein the second region collected signal data is used as reference data to perform real time offset correction to said first region signal data.

4. The x-ray imaging device according to claim 3, wherein said first region signal data collected from the first region is offset corrected for every pixel by the offset calibration functions as
$$OffsetCorrectedImage = \vert RawImage - OffsetCorrectionFunction ( Ref ) \vert ,$$
where the function argument Ref is the set of values of the reference data acquired from said second region of the application-specific integrated circuit simultaneously with the first region signal data collected from said first region of the application-specific integrated circuit simultaneously.
